(19) United States
(12) Patent Application Publication
(10) Pub. No.: US 2012/0193837 A1
(43) Pub. Date: Aug. 2, 2012

(54) APPARATUS AND METHOD FOR THE PRODUCTION OF PLASTIC CONTAINERS

(75) Inventors: Klaus Wasmuht, Ellingen (DE); Albert Link, Au (DE); Ulrich Lappe, Regensburg (DE)

(73) Assignee: KRONES AG, Neutraubling (DE)

(21) Appl. No.: 13/500,206

(22) PCT Filed: Oct. 15, 2010
(86) PCT No.: PCT/EP2010/006305

§ 371 Date: Apr. 4, 2012

(30) Foreign Application Priority Data
Oct. 15, 2009 (DE) 10 2009 044 258.8

(51) Int. Cl. B29C 49/10; B29C 49/58

(52) U.S. Cl. 264/532; 425/526

(57) ABSTRACT

Method and device for the production of plastic containers by blow molding or stretch blow molding of preforms, whereby the preforms are tempered, whereby the blow molds or stretch blow molds are possibly pre-heated before or during the blow molding or stretch blow molding process and whereby compressed air is injected into the preforms as blowing medium during the blow molding process. The blow molding and/or stretch blow molding devices as well as handling means and transport means are provided with operating power. The compressed air supply and/or the pre-heating means and/or the heating means and/or the drive means are powered by primary energy provided by at least one energy conversion device.

The invention relates to a device and a method for the production of plastic containers, especially PET containers, by a blow molding or stretch blow molding process.

### BACKGROUND

Economic units, manufacturing systems and all types of handling facilities or handling systems etc. require different types of energy. Foremost mechanical drive energy is required, which can be provided in the form of hydraulic and/or pneumatic pressure, thermal energy and electrical energy. The electrical energy is usually provided by an energy supply company and delivered over a public line network. For the supply of thermal energy different ways of delivery, production and/or use are possible. Mechanical energy as well as the energy source used for pneumatic and/or hydraulic drives and pressure supply are usually obtained by conversion of electrical energy, typically by means of electric motors.

### SUMMARY OF THE INVENTION

Until now the machinery used in beverage production is usually provided with energy and other media by completely independent energy supply routes and media supply routes. The required thermal energy is provided by a heat generating unit or generated in the machinery itself. Compressed air is provided by an air generator or a compressor, which is associated with the machinery (whereby a final pressure of up to 40 bar can be generated). The electric power is supplied through a power distribution system. For the energy and media supply it is conventionally assumed, that the different types of energy and media are essentially available and can be obtained from outside. Some kind of connection between energy generating processes and energy consumers is either only rudimentary available or nonexistent.

It is an object of the present invention to improve the processes involved in the filling of containers and in particular in the provision and manufacturing of the containers. The main objective is the improvement of the energy efficiency of the processes. The containers are usually produced by stretch blow molding of preforms. In this context, in particular the air supply for the stretch blow molding processes and/or the possibly required thermal energy for the stretch blow molding processes and/or for the mechanical drives are viewed and if possible improved with special focus on the required energy.

The present invention provides a device for the production of plastic containers by blow molding or stretch blow molding of preforms. The device comprises pre-heating means for the tempering of the preforms. Optionally the device includes heating means for warming the blow molds or stretch blow molds before or during the blow molding or stretch blow molding process and/or a compressed air supply for the delivery of the blowing pressure required for the blow molding process. The device may furthermore comprise drive means for operating the blow molding and/or stretch blow molding devices and drive means for the transport and the handling of the preforms and the final shaped PET containers. The invention provides that the pre-heating means and/or the heating means and/or the compressed air supply and/or the drive means are supplied with energy from energy conversion devices, the energy conversion devices being powered by primary energy. In the present context the term primary energy is particularly used for fuel, which is typically suitable for use in combustion engines. Such primary energy sources are biogas, natural gas, liquid fuel or hydrogen or the like. In thermal engines with an external combustion or heat supply, such us Stirling engines, solid fuels, exhaust heat or solar energy can also be used. Further energy conversion devices may be wind or water turbine drives.

The system components can be mutually coupled to each other. Preferably they are coupled mechanically and/or at least partially energetically. The coupling can especially be done via a common control. The system components each form mutually coupled energy conversion units, energy storage units and/or energy consumption units, which are powered by at least one common energy conversion device. The energy conversion device supplies mechanical operating power, which is furthermore called shaft energy, and/or electrical and/or thermal energy. As an energy generating device, for example, a gas motor, a gas turbine or another device, which is suitable for other primary energy sources such as a diesel internal combustion engine or a Stirling engine, can be used. Optionally this energy generating device may be coupled with the pre-heating means and/or with the possibly existing heating means and/or with the drive means and/or to an electric generator and/or to a compressor of the compressed air system. In the blow molding or stretch blow molding process the injection molded preforms are converted into the desired container shape by heating and subsequent application of internal pressure through the injection of compressed air. Naturally, the production of compressed air for the blow molding or stretch blow molding process is of particular interest, since the production of compressed air represents a very significant share of the energy consumption of such a container manufacturing and container treatment and bottling system. The energy consumption during the production of compressed air is so high, because sometimes very high blowing pressures (up to 40 bar) are required. The compressors, which are typically used for the provision of compressed air, have a significant share of the total energy consumption of a container-producing device. Even when considering the total energy consumption of the whole bottling system, the energy required for producing compressed air is of considerable dimension. Another significant energy consumer is the tempering device or pre-heating means for tempering the preforms before the blow molding process. Hereby mainly infra red radiation or microwave radiation is used, which is generally produced using externally generated electricity.

The gas turbine, gas engine or internal combustion engine used according to a preferred embodiment of the invention, is advantageously equipped with at least one heat exchanger, in particular with an exhaust gas heat exchanger. The heat exchanger is coupled to at least one of the components of the system, for instance the heat exchanger is coupled to the heating means for warming the blow molds and/or to the pre-heating means for tempering the preforms. Furthermore a coolant heat exchanger can be provided, through which the processing temperature of the primary energy converter (ie the motor) can be used energetically. The thus-provided thermal energy may be delivered to the blow molding process directly and/or via a heat storage unit, depending on the temperature levels provided by the container production process. The use of a layered heat storage system, whereby different temperatures are stored in different layers, can be particularly advantageous. Hereby a precision-fit temperature level-removal is possible. When thermally resistant PET containers should be produced via the “heat set” process, the thermal energy delivered from primary energy conversion can be used for pre-heating the preforms and or for heating the blow molds. In this way the current energy requirement for the generation of microwaves or infrared radiation can be reduced.

Furthermore the energy conversion device or the gas turbine, the gas engine or combustion engine can be coupled to further components of the system like the compressor of the compressed air system, mechanical drive units of the blow molding device or stretch blow molding device, especially to a blowing wheel or a blowing carousel and/or further transport means. The coupling is especially done via a mechanical transducer or via a gear drive. Such a mechanical transducer can be used to provide the mechanical power requirements via the turbine or the engine in a simple and energetically cheap and low-loss manner. As gear drive a continuously variable gear drive like a friction belt gear drive or the like can be used. It can possibly make sense to make the speed adjustments through a controlled coupling when starting or stopping the system. This is especially sensible when the drive speeds shows no greater fluctuations, since, for example, the process speeds are essentially the same level. The controlled coupling allows a specific slip control and thus a temporary speed adaptation, leading to a proper adjustment of the gear ratio. In order to minimize the losses of heat and pressure, the energy conversion device and/or the compressor for generating the compressed blowing air are appropriately arranged as close as possible to the blow molding device and to the pre-heating means for tempering the preforms.

According to a further embodiment of the device a plurality of blow molding units or stretch blow molding units is uniformly arranged over the circumference of a rotating blowing wheel. At least one energy conversion device, which is powered by a primary energy source, is preferentially arranged on top of the blowing wheel. The energy conversion device is especially required for supplying the blow molds or stretch blow molds with the required compressed air. Particularly advantageously, a plurality of energy conversion devices, each powered by a primary energy source, is arranged on such a rotating blowing wheel. Each blow molding unit especially comprises a separate pressure drive for the compressed air supply and/or for the supply of at least a part of the thermal energy required for the blow molding or stretch blow molding process. Such a compressed air drive can show a very compact design. A direct association with each blowing unit is quite feasible within existing devices. Therefore the existing devices can be upgraded easily. For hygienic reasons a primary energy source such as hydrogen can be advantageously used. Hydrogen is free from harmful substances and can be implemented without any adverse impact on the blowing air.

The stretch blow molding of the containers can be done, for example, with a hydraulically or pneumatically driven stretching rod. For the so-called pre-blowing a pressure level of about 6 bar to 10 bar is sufficient. This pressure can be supplied from other components of the processing system and is then called recycling air or recycling pressure. It can possibly be useful to use small pressure reservoirs as interim storage. Hereby very small compressors can be used, which can be operated quite inexpensively. The blowing process is completed by an injection of hot air, which introduces additional thermal energy. Therefore the thermal energy required for the blow molding process is not only introduced by heating the blow molds but also through the injected compressed air. The compressed air is furthermore required for the formation of the final container shape. The blowing air is generated in an advantageous manner with primary energy. Thereby a limitation of up to 25 bar might be sensible. This pressure level can be generated in the machinery itself. This can especially be done in a decentralized manner via a controlled explosion of a suitable gas. Apart from hydrogen, all other fuel gases, which are generally referred to as primary energy sources, can be used. Biogas can also be used suitably for the above purpose. For instance a methane gas, which is produced via a biogas generating process, can be used suitably. The explosion, which is required for using the primary energy stored in the gas, can be used to propel a piston that is guided within a combustion chamber. This is comparable to the known Otto engine, diesel engine or gas engine like a Sterling engine. Hereby the said piston movement drives a compression piston in a mechanical way, for example with a slider crank mechanism or in another suitable way. Thereby the sucked ambient air gets compressed to the required pressure level of about 25 bar or possibly even more in a single compressor stage. The fact that the compressed air gets very hot during the compression process, can be used advantageously for internal heating and sterilization of the preforms. If the temperature level during compression gets too high, it may be necessary or useful to use an intermediate cooling step. The exhaust heat can be advantageously used and further processed through heat exchangers.

The derived compressed air can be used without further treatment for the blow molding process of containers and bottles. The bottles are kept firm or stable through the cooling of the plastic at the outer surface, which is contacting the blow mold. The bottles are furthermore stabilized through the so called expansion cold resulting from the relief of the bottles at the end of the bottle blowing process. Additionally the hot air can improve the microbiological conditions inside the bottle and inside the air system of the blow molding device. Especially the inside of the bottles and the air system of the blow molding device can be kept largely sanitized and germ-free.

A particular advantage of the described configuration is that the standard air-cooling followed by air-drying, which is generally used in external compressors, can be omitted. This is energetically advantageous, because these two processes require a lot of energy. Instead of the usual powering of the compressor with an electric current, it can be operated directly with primary energy. Thereby conversion losses are reduced and the carbon dioxide balance is improved. If a central primary energy engine is used, only all the mechanical drives can be operated. This means that for instance the blowing wheel, the transport chain in the pre-heating means, hydraulic pumps, blowers etc. can be operated. The hot exhaust gases of the primary energy engine can also be used for heating or pre-heating the combustion medium (gas). The hot exhaust gases can also be used for the operating of an adsorption refrigeration system for cooling the molds. In hot filling lines the temperature control circuits can be supplied with energy via suitable heat exchangers.

The present invention furthermore relates to a method for the production of plastic containers by blow molding or stretch blow molding of preforms. The preforms are first tempered to a required temperature. The blow molds or stretch blow molds are heated possibly before or during the blow molding or stretch blow molding process. The preforms are then injected with compressed air, which is used as blowing medium for the blow molding process. According to the inventive process the blow molding or stretch blow molding devices as well as handling devices and transport devices are powered by mechanical operating power. It is provided that in the inventive process the pre-heating means and/or the heating means and/or the compressed air supply and/or the drive means are powered by primary energy. Optionally several blowing units can each be operated with separate energy conversion devices, whereby the energy conversion devices are each powered by primary energy. For instance each blow molding unit can be supplied by a separate pressure drive, the pressure drive providing the required compressed air as well as at least a part of the required thermal energy for the blow molding or stretch blow molding process.

Additionally it should be noted, that steam turbines can also be used. This can be especially suitable and advantageous in system environments with high amounts of steam production. In breweries relatively large amounts of steam are produced in the brewhouse. The energy content of the steam can be partially recovered by means of steam turbines. These steam turbines can be used for example to generate electricity by driving generators. If necessary, it is also possible to use the mechanical energy of the steam turbine shaft (also called wave energy or shaft energy) to generate compressed air directly by means of directly driven compressors.

The inventive device may be part of a system for the manufacturing, bottling, packaging and/or transport of beverages in beverage containers, whereby the components of the system are mechanically coupled. The components are furthermore coupled via a common control and the components are mutually coupled to one another at least partially energetically. In addition, the system components that are mutually coupled to one another each form energy conversion units, energy storage units and/or energy consumption units. These units are provided with energy through at least one common energy generating device, which supplies mechanical operating power or shaft energy and/or electrical energy and/or thermal energy. The common energy generating device especially comprises at least one gas turbine or another suitable combustion engine, which is mechanically coupled to an electrical generator and/or to a compressor of a compressed air system. The gas turbine or the engine can furthermore comprise at least one heat exchanger, whereby the heat exchanger is coupled to at least one of the system components. Particularly an exhaust gas heat exchanger can be used as a heat exchanger, whereby the exhaust gas heat exchanger uses the thermal energy stored in exhaust gas. This thermal energy can then be provided to other heat consumers, like a shrinking tunnel, a film tempering device or other heat consuming components of the processing system. Additionally or alternatively, a heat exchanger may be provided, which uses the thermal energy contained in the cooling fluid of the gas turbine or engine and provides this energy to other consumers.

When coupling the mentioned units in an inventive device it may be particularly advantageous if the energy generating device or the gas turbine supplies the energy for at least one dry end-block of the container treatment system and/or the beverage filling system or a part thereof. Thus, a part of the exhaust heat energy or the whole exhaust heat energy, which is obtained from the heat exchanger units of the gas turbine, can be used for different purposes. It may be advantageous, for example, to energetically couple the energy generating device or the gas turbine to at least one heating means of the container treatment system. The exhaust heat can be effectively used for a pre-heating means for tempering the preforms and/or for blow molding unit. A shrinking tunnel of a packing system can be advantageously supplied with heat, since the energy consumption in a shrinking tunnel is particularly high. Furthermore the energy generating device or the gas turbine can be energetically coupled to a compressed air supply of at least one packaging system. This is typically a mechanical coupling, whereby the shaft power of the gas turbine is used for powering the compressors used for generating the compressed air either directly or indirectly. An indirect drive can, for example, be generated via a transformation of the driving power into electrical energy by a generator and a compressor drive with an electric motor. Thereby more flexible actuator control options can be obtained.

In the present context, both the potential use as well as the integration of a combined heat and power coupling is described. The heat and power coupling is especially used and integrated into the processes of beverage production, bottling and packaging, as well as in the process of the transportation of pallets with beverage containers and other related and/or linked processes. A method is explained, whereby alternative energy generating system are integrated in the process of beverage production, bottling and beverage packaging, and the transportation of beverage pallets. The system components and machinery used in the beverage industry usually require heat, electricity and compressed air for the production processes. The required electricity can be produced with the heat and power coupling according to the invention. This is especially done by including a micro gas turbine, whereby electricity is produced by the combustion of gas or biogas. The exhaust heat produced during the combustion of the gas can, for instance, also be used for the heating of buildings. Furthermore this thermal energy can also be provided to other system components. The intelligent coupling of the beverage production system with a micro gas turbine can be advantageously used to provide the exhaust heat to the machinery required for the shrinking process, to the machinery required for the tempering of the used materials or to the machinery for tempering the used media. The exhaust heat is thereby supplied directly or indirectly. The resulting electricity can be used for the operation of drives, fans, motors, generators, radiators etc. Excess electricity can be fed back into the network (either public or in-house) and/or used elsewhere. A compressed air generating system for supplying the required compressed air to the beverage production system can be integrated into the system by using a mechanical extension of the micro gas turbine. Organic waste from the beverage production process can be fed into the micro gas turbine and used as fuel. In known beverage production systems the various system components usually have completely independent supply routes for the provision with energy and media. The inventive coupling therefore has several advantages. Conventionally the required heat is supplied by a separate heat generating unit or generated in the beverage production system itself. The inventive power and heat coupling provides the exhaust heat as a kind of a waste product. According to the invention the required compressed air is not supplied by an air generator. Instead the compressed air is derived from the mechanical operating power or shaft energy of the combustion engine. Also, the required electricity is not obtained from a conventional power distribution system, but generated by the power and heat coupling. In the case where a conventional energy and media supply is used, it is assumed that these are available to 100% anytime. An intelligent coupling of energy production processes and energy consumers is not known and used in any conventional system.

The invention overcomes the described drawbacks by using a micro gas turbine or a gas engine or the like, which is able to drive a generator to produce electricity. The micro gas turbine or a gas engine can furthermore power a compressor for generating compressed air, whereby the turbine or engine is coupled to the compressor either directly or indirectly. Both the generator and the compressor can be independently switched on or off. The exhaust gas, which is produced during the combustion in the micro gas turbine, is cooled down in an exhaust gas heat exchanger by a suitable exchange medium. Thereby the exchange medium (steam, heating water, air) is used as heat source for a beverage processing system (shrinking tunnel, blow molding oven, CIP-machinery etc.). Both purchased gas as well as biogas can be used as fuel. The biogas can be derived from organic waste, which is a waste product of the beverage production process. An intelligent control system coordinates and optimizes the control processes of the micro gas turbine, the exhaust exchange system and the beverage processing system.

In addition it may be mentioned, that the coupling of energy generating devices—especially of the so called micro gas turbine—and the energy consumers of the inventive system can also be used only in a so-called dry end-block of the processing system. This variation is slightly restrictive and not always necessary. It may well be advantageous to provide energy consumers, which are part of the so-called wet end-block of a filling system, energetically, thermally, electrically or in another suitable way via a gas turbine or one of the other energy generating devices.

According to the invention the thermal energy and electric energy and/or pneumatic energy required by the various components of a processing system can be provided advantageously by the energy generating device. Thereby not only the total energy cost of the entire system can be significantly reduced. The use of heat storage units, especially layered heat storage units, is very favorable. The inventive system furthermore shows a significant reduction in the emissions of climate-damaging carbon dioxide. Thereby the invention can provide a valuable contribution to the conservation of energy resources and to the protection of the environment from climate-relevant emissions.

Through the heat and power coupling in particular an energetically optimized blow molding device for the manufacturing of plastic containers can be provided. Preferably such a blow molding device can be used for stretch blow molding PET bottles with a low “carbon footprint”.

### BRIEF DESCRIPTION OF THE DRAWINGS

In the following passages, the attached figures further illustrate exemplary embodiments of the invention and their advantages. The exemplary embodiments of the invention are illustrative, but are not limiting in any way.

FIG. 1 shows a schematic block diagram of an embodiment of a device according to the invention.

FIG. 2 shows an exemplary configuration of a so-called disposable PET line-machinery, whereby PET containers are formed from PET preforms, which are then filled with beverages.

FIG. 3 shows a first embodiment of a compressed air motor for generating compressed air from primary energy.

FIG. 4 shows a further embodiment of such a compressed air motor.

FIG. 5 shows an exemplary configuration of a beverage filling system.

### DETAILED DESCRIPTION

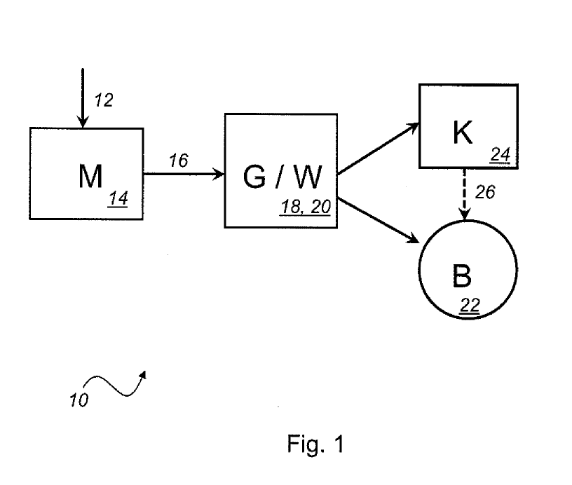

The schematic representation of FIG. 1 shows a highly schematic block diagram of an embodiment of the inventive system or inventive device 10. A motor 14 (“M”) is powered by primary energy 12. The motor 14 is mechanically connected to a converter 18 (“W”) and/or a gear drive 20 (“G”) via a shaft connection 16. The energy from the motor 14 is provided to the converter 18 (“W”) and/or to the gear drive 20 (“G”), which in turn provide the power to further components of a blow molding or stretch blow molding device 22 (“B”). The gear drive 20 or the converter 18 preferentially drive a compressor 24 (“K”) and possibly other components (not shown here) like generators or the like. This may also be, for example, an oven chain, an oven wheel, a heating chain or the like. The converter 18 and/or the gear drive 20 are used for the adjustment of the rotation speed for uneven speed processing of the blow molding device 22 or even for the adjustment of the rotation speed at different engine speeds. The compressor 24 may form the central compressed air generator 26 for providing the blow molding device 22 with the required compressed air.

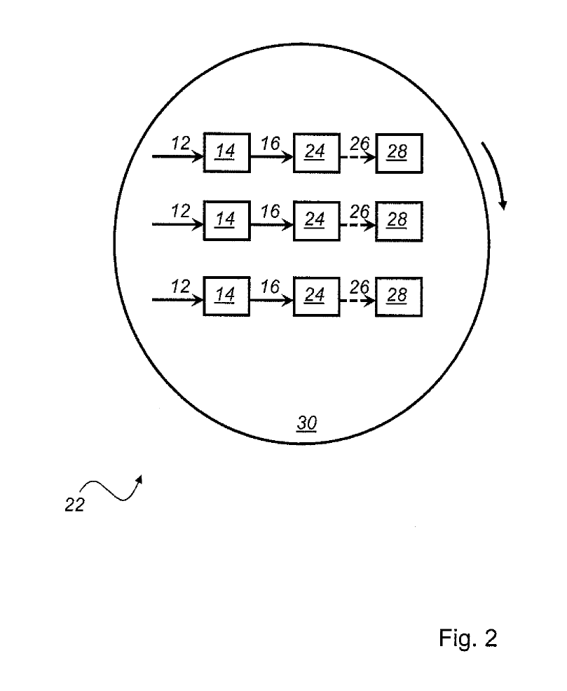

The representation of FIG. 2 shows an alternative embodiment of the device 10, whereby essentially each blowing unit 28 of a stretch blow molding device 22 comprises its own compressor 24. Several units, each consisting of a motor 14, a compressor 24 and a blow molding unit 28, are arranged on the rotating blowing wheel 30 of the stretch blow molding device 22. Each motor 14 can be supplied with fuel such as hydrogen through a central power supply 12.

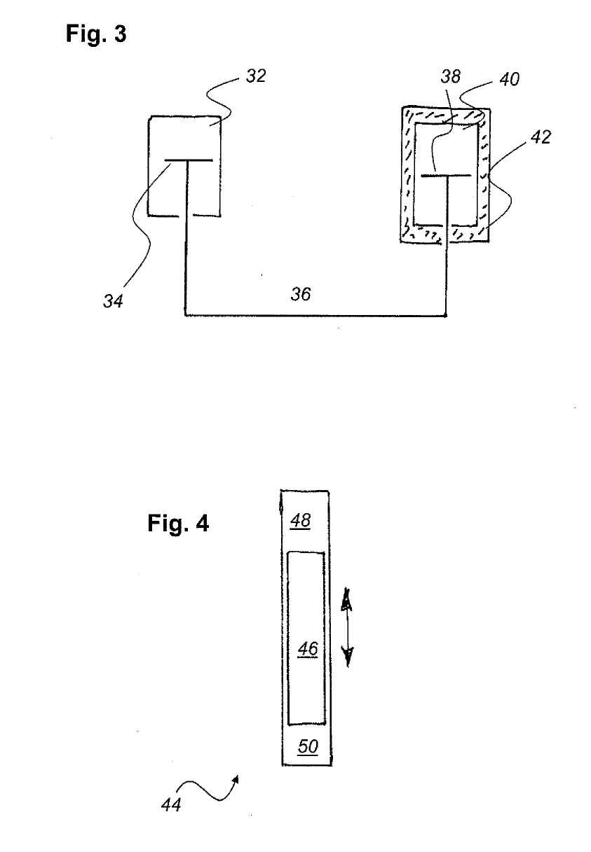

Based on the representation of FIG. 3, different types of pressure drives or compressed air motors are described. The stretch blow molding of the containers from preforms may, for example, be done with a hydraulically or pneumatically driven stretching rod. A pressure level of about 6 bar to 10 bar is sufficient for the so-called pre-blowing of the containers. This pressure can optionally be supplied from other components of the processing system. By injecting hot air, the blowing process is subsequently completed. The thermal energy, which is required for the formation of the final container shape via the blowing process, is introduced into the containers through the pre-warmed blow mold and by the injection of hot compressed air. This blowing air is generated with primary energy 12, wherein a restriction of up to 25 bar is sensible. This pressure level can be generated in the device through a controlled explosion of a suitable gas. In addition to hydrogen all fuel gases can be used, which are generally referred to as primary energy 12. The explosion required for the use of the primary energy stored in the gas can be used to drive a piston 34, whereby the piston 34 is guided within a combustion chamber 32. The piston movement drives a compression piston 38 in a mechanical way, ie for example via a slider-crank mechanism or another suitable coupling 36. The compression piston 38 thereby moves within a compressor cylinder 40. In a single compressing stage the compressor 38, 40 compresses the sucked up surrounding air to the pressure level required for the blow molding process. During compression the air gets very hot. This can be used advantageously for the inner pre-heating of the preforms. If the temperature reached during compression is too high, an intermediate cooling might be necessary, whereby the exhaust heat can be further stored and processed by using heat exchangers. In order to use the thermal energy contained in the compressed air, a heat exchange jacket 42 may be provided.

The schematic representation of FIG. 4 shows an alternative embodiment of such a pressure drive or compressed air motor, for example a so-called free-piston engine 44. This free-piston engine 44 combines a thermal engine with an internal or an external combustion and a working machine in the form of a compressor. The direct, engine-free transmission of the cyclic motion of the piston 46 of the thermal engine from the combustion chamber 48 to the compressor section 50 is characteristic for this free-piston engine 44. Thereby any mechanical engines, such as a crank mechanism, can be omitted. The power output is not mechanical. The free-piston engine 44 can be designed very compact. The free-piston engine 44 is furthermore characterized by great simplicity and a high power to weight ratio. Such machines can thus be remotely assigned to or arranged on each blowing unit 28, as indicated in FIG. 2.

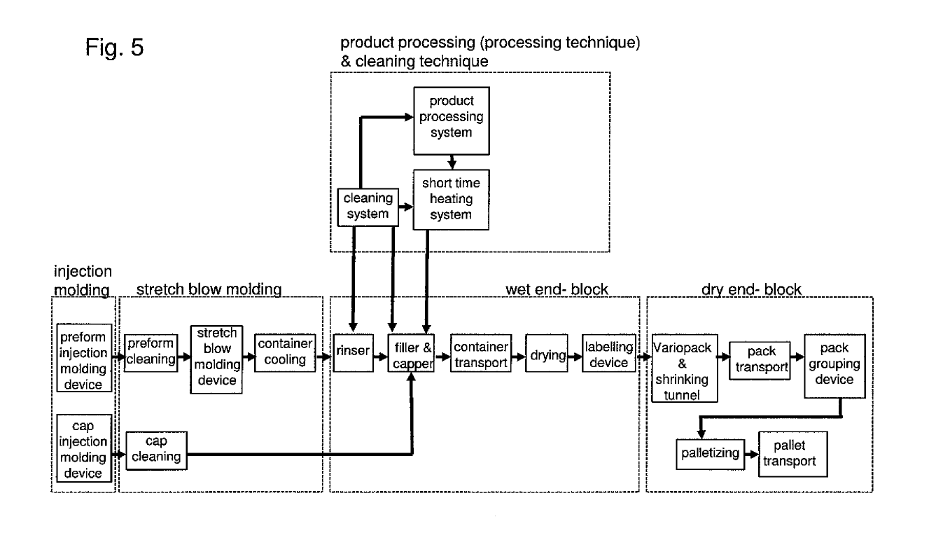

The schematic block diagram of FIG. 5 illustrates an exemplary configuration of a beverage filling system, especially for disposable PET containers. PET containers are formed from PET preforms and subsequently filled with beverages. The leftmost shown first processing station comprises a preform injection molding device, whereby preforms of a thermoplastic material are produced by injection molding, especially whereby PET preforms are produced. It furthermore comprises a cap injection molding device, whereby completely shaped caps are produced by injection molding. The thermal energy required for the injection molding process, especially for melting the plastic material or plastic granulate to be processed, can be obtained in particular from the exhaust heat of the gas turbine. If necessary, the hydraulic pressure required for the injection molding process can also be obtained from the mechanical operating power or shaft energy of the gas turbine. Typically this can be done through a direct coupling of a hydraulic pressure generator or a hydraulic pump to the rotating shaft of the gas turbine. Optionally a mechanical-electrical conversion might be arranged in between, so that the hydraulic drive can be operated either directly from the gas turbine or by an electric motor.

The subsequent system component comprises the so called stretch blow molding. First the preforms are cleaned and subsequently fed into a stretch blow molding device. Here the preforms are first tempered and then placed in the blow molds, where they are blow molded in the desired shape through the application of inner pressure. The heat required for tempering the preforms may optionally be recovered from the exhaust heat of the gas turbine. Alternatively the required heat can be applied by electrical heating devices such as infrared radiators. Particularly the electrical heating devices can be supplied with electrical energy from the energy generating device. The containers formed by stretch blow molding are then cooled down. Depending on the system configuration this can be done by using suitable heat exchangers. The heat exchangers can also be energetically coupled to the energy generating device and/or to other system components.

The final shaped containers together with the cleaned caps (see cap cleaning device) are then transferred to the so-called wet end-block of the filling system, where the filling of the beverages takes place. The cleaning of the containers prior to filling with liquid may be done, for example, in a so-called rinser. Subsequently the bottles are filled in a filler and closed in a capper. The stages of product processing, especially the processing technique, and the cleaning technique are coupled to the wet end-block. This is shown by the arrangement of this processing block above the wet end-block. The product to be filled, for example the beverage, is delivered from the product processing plant to the filler. Optionally a short-time heating system is arranged in between the product processing plant and the filler. In the so-called cold filling a short-term heating is not required. A conventional filling generally provides that the beverage is heated before filling to ensure the stability and sterility or to ensure that germs are eliminated at least to a large extend. This short-time heating system can also advantageously utilize the exhaust heat of the energy generating device, for instance via the exhaust gas heat exchanger of the gas turbine or something similar. Both mentioned system components of the product processing as well as the rinser and the filler are additionally connected to a cleaning system.

After filling the containers and their subsequent closure via the capper, they are fed via suitable container transportation to a drying unit. The drying unit comprises, for instance, a hot air blowing system. Hereby the exhaust heat of the gas turbine can be used again. The containers are usually labeled after drying. According to FIG. 5 this is done by a labeling device. In normal linguistic usage the labeling device is part of the wet end-block. Other types of container labeling are also possible, for example, a printing of a label or a direct printing of the container. This typically takes place in the dry state of the containers. The electrical and/or pneumatic energy required by the labeling device, can be supplied preferably with electrical energy, which is produced by the energy generating device by means of the electric generator. Other system components can also be provided with this electrical energy, for instance transport units, fillers, cappers or the like.

A so called dry end-block of the system is located downstream of the wet end-block. This dry end-block comprises a packaging unit, which is for instance a so-called Variopack-system. This Variopack-system comprises a film wrapping unit for wrapping packs of several containers with shrinking film, subsequently heating the film in a shrinking tunnel and further subsequently arranged transport devices. The shrinking tunnel is a particularly energy consuming unit of the system. Therefore the operation of the shrinking tunnel with the exhaust heat from the gas turbine is particularly desirable. The use of energy obtained through the exhaust gas heat exchanger has a large energy saving potential, since the operation of such shrinking tunnels usually causes relatively high energy costs. The subsequent transport of the packs conveys these packs to a grouping unit and a downstream palletizing unit. The pallets can then be transported to a warehouse for storage or the pallets are transferred to further transportation facilities such as delivery trucks or the like. These mentioned units can also be supplied with electrical or pneumatic energy provided by the system.

The features of the invention disclosed in the foregoing description, the drawings and the claims can be used in its various embodiments either individually or in any combination for the realization of the invention. The invention has been described with reference to preferred embodiments. To the expert it is also conceivable, however, to make changes and modifications without leaving the scope of protection of the appended claims.

The illustrated figures, which have been described above, represent only possible embodiments. Especially it cannot be derived, that a use of the invention in a multi-line or in processing technique should be excluded. Even in such applications, the inventive energy coupling can be used advantageously.

What is claimed is:

1-11. (canceled)

12. A device for the production of plastic containers by blow molding or stretch blow molding of preforms, the device comprising:
at least one of the following facilities: a pre-heater for tempering the preforms, a heater for warming the blow molds or stretch blow molds before or during the blow molding or stretch blow molding process, a compressed air supply for the delivery of the blowing pressure required for the blow molding process, and a drive for operating a blow molding and/or stretch blow molding device, a further drive for operating the transport and the handling of the preforms and the blow molded PET containers;
at least one of the compressed air supply, the pre-heater, the heater, the drive and the further drive being supplied with energy from at least one energy conversion device powered by primary energy.

13. The device as recited in claim 12 wherein system components of the device are coupled mechanically and/or at least partially energetically, the system components of the device each forming mutually coupled energy conversion units, energy storage units and/or energy consumption units, the energy conversion units, energy storage units and/or energy consumption units being supplied by at least one common energy conversion device of the at least one energy conversion device, which provides mechanical operating power and/or electrical energy and/or thermal energy.

14. The device as recited in claim 13 wherein the system components of the device are coupled via a common control.

15. The device as recited in claim 12 wherein the energy conversion device comprises at least one gas engine, gas turbine or any other combustion engine or other drive suitably using a primary energy source, the energy conversion device being coupled to at least one of the pre-heater, the heater, the drive, the further drive, an electrical generator, and a compressor of the compressed air supply.

16. The device as recited in claim 15 wherein the gas engine, the gas turbine or the combustion engine comprises at least one heat exchanger coupled to at least one of the components of the system and/or coupled to at least one heat storage device.

17. The device as recited in claim 16 wherein the heat exchanger is an exhaust gas heat exchanger.

18. The device as recited in claim 15 wherein the energy conversion device or the gas turbine, the gas engine or the combustion engine or any other drive is coupled to further components or system components via a mechanical transducer or via a gear drive.

19. The device as recited in claim 18 wherein the further components or system components include at least one of a compressor of the compressed supply, mechanical drive units of the blow molding device or stretch blow molding device, a blowing wheel or a blowing carousel and a further transport device.

20. The device as recited in claim 12 wherein a plurality of blow molding units or stretch blow molding devices is uniformly arranged over the circumference of a rotating blowing wheel, the at least one energy conversion device supplying the blow molds or stretch blow molds with the required compressed air, the at least one energy conversion device being powered by a primary energy source for the primary energy.

21. The device as recited in claim 20 wherein the energy conversion device is arranged on top of the blowing wheel.

22. The device as recited in claim 20 wherein the at least one energy conversion device includes a plurality of energy conversion devices, each powered by the primary energy source, and arranged on top of the rotating blowing wheel, a separated pressure drive being assigned to each blow molding unit, the pressure drive being required for supply of the blow molds or stretch blow molds with compressed air and/or for the supply of the blow molds or stretch blow molds with at least a part of a required thermal energy.

23. A method for the production of plastic containers by blow molding or stretch blow molding of preforms, the method comprising:
tempering the preforms, the blow molds or stretch blow molds being possibly pre-heated before or during the blow molding or stretch blow molding process;
injecting compressed air into the preforms as a blowing medium during the blow molding process; and
providing blow molding and/or stretch blow molding devices as well as a handling device and transporter with drive energy,
at least one of a compressed air supply, a pre-heater, a heater and a drive being powered by primary energy provided via at least one energy conversion device.

24. The method as recited in claim 23 whereby several blow molding units are each operated by separate energy conversion devices, the energy conversion devices each being powered by the primary energy.

25. The method as recited in claim 24 each blow molding device is provided with a separate pressure drive supplying the compressed air as well as at least a part of the thermal energy required for heating the blow molds or stretch blow molds.

26. The method as recited in claim 23 wherein the primary energy for the energy conversion device is converted into mechanical operating power for the blow molding or stretch blow molding devices.

27. The method as recited in claim 26 wherein accumulating thermal energy is transferred to at least one heat storage unit or directly transferred to and used in the blow molding or stretch blow molding process of the plastic containers.

28. The method as recited in claim 27 wherein the heat storage unit is a layered heat storage unit.

29. The method as recited in claim 27 wherein the plastic containers are PET bottles.
